(19) United States
(12) Patent Application Publication
(10) Pub. No.: US 2025/0217202 A1
(43) Pub. Date: Jul. 3, 2025

(54) System and Methods for an Elastic Software Process Execution Environment

(71) Applicant: Appian Corporation, McLean, VA (US)

(72) Inventors: Brian Joseph Sullivan, Bethesda, MD (US); Antonio Andrade Garcia, Reston, VA (US); Richard Pat Zwiren, JR., Montclair, NJ (US); Paul Francis O'Brian Dellinger, Raleigh, NC (US); David Kurt Loewy, Falls Church, VA (US)

(73) Assignee: Appian Corporation, McLean, VA (US)

(21) Appl. No.: 18/403,104

(22) Filed: Jan. 3, 2024

(51) Int. Cl. G06F 9/50

(52) U.S. Cl. CPC G06F 9/505

(57) ABSTRACT

Disclosed are methods, systems and non-transitory computer readable memory for an elastic software process execution environment using an object-based model. For instance, a system may include an elastic executor and elastic datastore. The system may assign a first process node of a plurality of process nodes of a software process to a first executor of a plurality of executors, such that tasks associated with the first process node will be executed by the first executor; and assign a second process node to a second executor of the plurality of executors, such that tasks associated with the second process node will be executed by the second executor. The tasks may cause updates to variables shared between the tasks and/or executors.

### TECHNICAL FIELD

Various aspects of the present disclosure relate generally to systems and methods for an elastic software process execution environment and, more particularly, to systems and methods for an elastic software process execution environment using an object-based model comprising a plurality of process nodes.

### BACKGROUND

Generally, elastic software process execution environments require specialized knowledge on how to manage scalability, manage process and time pipelines in an efficient, and/or manage cost of discrete sub-components. However, no-code or low-code users may not consider or have access to these aspects while developing software processes. In order to leverage best practices and maintain system balance, efficiency, correctness, and data security and integrity, there is a need for elastic software process execution environments to support low code or no-code software processes.

The present disclosure is directed to overcoming one or more of these above-referenced challenges.

### SUMMARY OF THE DISCLOSURE

According to certain aspects of the disclosure, systems, methods, and computer readable memory are disclosed for an elastic software process execution environment using an object-based model comprising a plurality of process nodes.

In some cases, a system for elastic execution of user-defined software processes may include: a frontend configured to receive user inputs related to a software process, wherein: the software process is configured to be represented in an object-based model comprising a plurality of process nodes, the plurality of process nodes comprising at least a first process node and a second process node; and at least a set of the plurality of process nodes retrieve and perform operations on values of variables associated with the software process; at least one datastore configured to store the values of the variables associated with the software process; and a plurality of executors, each of the plurality of executors being configured to execute tasks associated with one or more of the plurality of process nodes. The system may be configured to: assign the first process node to a first executor of the plurality of executors, such that tasks associated with the first process node will be executed by the first executor; assign the second process node to a second executor of the plurality of executors, such that tasks associated with the second process node will be executed by the second executor; and execute the software process, wherein executing the software process comprises: assigning, to the first executor, a first set of tasks associated with the first process node, wherein executing the first set of tasks causes at least a first value of the variables associated with the software process to be modified in the at least one datastore; and assigning, to the second executor, a second set of tasks associated with the second process node, wherein executing the second set of tasks causes at least the first value of the variables associated with the software process to be again modified in the at least one datastore.

In some cases, a computer-implemented method for elastic execution of user-defined software processes may include: receiving user inputs related to a software process, wherein: the software process is configured to be represented in an object-based model comprising a plurality of process nodes, the plurality of process nodes comprising at least a first process node and a second process node; each of the plurality of process nodes of the plurality of process nodes corresponds to a software subroutine; and at least a set of the plurality of process nodes retrieve and perform operations on values of variables associated with the software process; storing the values of the variables associated with the software process; assigning the first process node to a first executor of a plurality of executors, such that tasks associated with the first process node will be executed by the first executor; assigning the second process node to a second executor of the plurality of executors, such that tasks associated with the second process node will be executed by the second executor; and executing the software process, wherein executing the software process comprises: executing, using the first executor, a first set of tasks associated with the first process node, wherein executing the first set of tasks causes at least a first value of the variables associated with the software process to be modified in at least one datastore; and executing, using the second executor, a second set of tasks associated with the second process node, wherein executing the second set of tasks causes at least the first value of the variables associated with the software process to be again modified in at least one datastore.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts an example environment for an elastic software process execution environment using an object-based model comprising a plurality of process nodes.

FIG. 2 depicts a diagram schematically showing an object-based model comprising a plurality of process nodes.

FIG. 3 depicts a block diagram schematically showing how tasks are assigned to executors in an elastic software process execution environment.

FIGS. 4A and 4B depict dataflow diagrams for a software process hosted on an elastic software process execution environment.

FIG. 5 depicts a block diagram schematically showing how tasks are executed on executors in an elastic software process execution environment.

FIG. 6 depicts an example system that may execute techniques presented herein.

### DETAILED DESCRIPTION

In general, the present disclosure is directed to methods and systems for an elastic software process execution environment using an object-based model comprising a plurality of process nodes. As discussed in detail herein, systems of the present disclosure may provide elastic executors and elastic datastores to dynamically match a load caused by software processes being hosted on the systems.

For instance, a unit of concurrency in an elastic software process execution environment may be defined by the total number of subgroups (e.g., that manage queues of tasks to be processed by an executor), but a unit of parallelism of the elastic software process execution environment may be defined by a total number of executors (e.g., each, individually, configured to run software for a task of a software process using user-defined or third-party-defined software code on VMs). In some cases, the parallelism may also be defined by the total number of threads a multi-threaded executor uses. In some case, a single executor can consume tasks from any number of subgroups, while a single subgroup may feed tasks to only one executor.

In some cases, elastic scalability may be achieved by expanding and contracting the number of executors at runtime. Generally, elastic or scalable infrastructure described herein may mean the ability to dynamically and in real-time add or remove resources (e.g., executors or datastores) dedicated to a particular object in question (e.g., software subroutine, software process, subgroup, group, and the like). In some cases, the elastic software process execution environment may rely on, e.g., metrics to scale executor deployments based on the number pending tasks/queue size. As a number of executors vary, subgroups may be rebalanced to aim for an even distribution of subgroups across available executors. When the load is negligible or sporadic, executors may scale to zero (e.g., no infrastructure cost). In some cases, when performing computationally-intensive operations or retrieving large amounts of data from a data store (for certain tasks or software processes), the elastic software process execution environment allocates additional resources (e.g., executors and/or datastores) to the retrieve, store, process, and output results to achieve performance within a threshold range of a standard operational expectation. When those conditions are no longer present, those resources can be deallocated. In some cases, based on observed system behavior (e.g., a specific executor has exceeded an average process time for a process node or software process), the elastic software process execution environment may allocate resources to more queued or incoming tasks to other executors to ensure queue times for all software processes remains within a threshold range of standard operations expectations. These types of processes of allocating and deallocating resources on demand may be known as elastic scaling.

In some cases, subgroups may belong to a group, and those groups and subgroups can scale up and down according to need. The elastic software process execution environment may control the level of concurrency (i.e. number of subgroups) by draining tasks from one group (e.g. with 100 subgroups) to a new group (e.g. with 200 subgroups). Groups may also provide work affinity that allow the elastic software process execution environment to distribute different types of workloads to different groups. Moreover, the elastic software process execution environment may distribute tasks even to different subgroups within a group (e.g., if not dependent on each other).

In some cases, the elastic software process execution environment may provide workload isolation and/or reliability. For instance, executors may run user-defined and third-party software code (e.g., SAIL Expressions, expression language code, Java code, C++ code, or other compiled code) within virtual machines (“VMs”) of executors. Such code may contain instructions which produce computations which will be repeated a very high or even infinite number of times (e.g., an infinite loop) causing runaway execution, and if not interrupted will consume computing resources for a very long time, possibly indefinitely or ever-increasingly. The consumption of computing resources (e.g., compute resources or memory resources) by such code by a single process can cause other processes to have access to fewer resources and thus run more slowly. One way to address this problem is to provide isolation controls that establish limits on the resources available to that code so that the execution of other code is not impacted. VMs can be created with boundaries on the amount of resources available to the code being executed upon them, thus isolating the impact of their execution from code executing within other VMs. Thus, the elastic software process execution environment may greatly diminish the possibility that non-optimized or malicious code affects the performance or execution of other code. Furthermore, the elastic software process execution environment may isolate problems within: (1) a node execution itself, thereby protecting unrelated node executions; (2) the subroutine software process instance associated with the node execution, thereby protecting unrelated software process instances; (3) the software process, thereby protecting unrelated software processes; and (4) protecting the system resources of the elastic software process execution environment. For instance, in some case, the elastic software process execution environment may favor (e.g., weigh in a load balancing of tasks), or even restrict, the execution of a given software process, software process node, or a software process node instance (in run time) to a particular executor instance or type.

In some cases, the elastic software process execution environment may increase the cost-effectiveness of scaling and/or increase system throughput. For instance, VM startup and resource allocation is not immediate, calls to storage are neither free nor instantaneous, setup/teardown time is not negligible, and queuing times are unpredictable (e.g., timespan between enqueuing and fetching a task may widely vary). The elastic software process execution environment addresses these problems by adjusting resource consumption (e.g., compute, memory, I/O, storage) dynamically in response to resource needs posed by application usage while also providing workload isolation boundaries.

Moreover, the elastic software process execution environment may drive task allocation and consumption by application code, and not by system bookkeeping. For instance, the elastic software process execution environment may minimize unnecessary setup, teardown, or scheduling overhead by merging as many computations within a single executor as possible, as long as doing so does not affect the results of the computations (e.g., because the outcome of some of the computations is dependent upon data whose value may change and which is not contained within the execution environment). The elastic software process execution environment may minimize storage access costs by limiting the number, size, and/or frequency of API calls. For example, the execution environment may optimize process execution by composing tasks of the same process into a single unit of work, and storing any side effects of each task in a local cache which can be read by subsequent tasks, or aborting tasks with unbounded storage access.

Furthermore, the elastic software process execution environment may provide (approximately) constant single-software-process end-to-end latency. A single-software-process end-to-end latency may be the time to takes to initiate a start of a software process to when that software process has completed its process nodes (via however many mutually exclusive or otherwise pathways). In some cases, latency for a particular software process may tracked, e.g., as an average. In some cases, latency for a group of software processes (e.g., for an organization, user, or group of users) may be tracked, e.g., as an average. In some cases, latency for a type of software process (e.g., a set of software processes that perform a similar function) may be tracked, e.g., by an average. For instance, as long as the elastic software process execution environment is not saturated (e.g. executors falling behind due to volume of tasks), the elastic software process execution environment may ensure end-to-end latency of any given software process remains (approximately) constant as a scale/throughput increases for the system as a whole. In some cases, the elastic software process execution environment may be driven by an aggregate execution time of all nodes/executors, and not by queuing times or system overhead. For example, the elastic software process execution environment may: (1) prevent tasks from being stuck behind slow, unrelated, tasks; and (2) prevent long-running node executions from killing the elastic software process execution environment throughput or shooting up end-to-end latencies for unrelated processes.

Additionally, the elastic software process execution environment may ensure core components (i.e. compute layer, storage layer, task management) can be replaced with a functional-equivalent implementation to allow the elastic software process execution environment to evolve over time and support different deployment environments (e.g. site clusters, self-managed, serverless, etc.). In this manner, the elastic software process execution environment may provide distinct scalability, reliability, and/or security guarantees for different site hosting requirements. For instance, the elastic software process execution environment may determine to deploy processes (beyond some load threshold) in a dedicated serverless environment. In some cases, the elastic software process execution environment may use RDBMS-based storage (e.g. as a fallback for self-managed deployments).

Thus, methods and systems of the present disclosure may be improvements to computer technology and/or no-code/low-code platforms.

### Environment

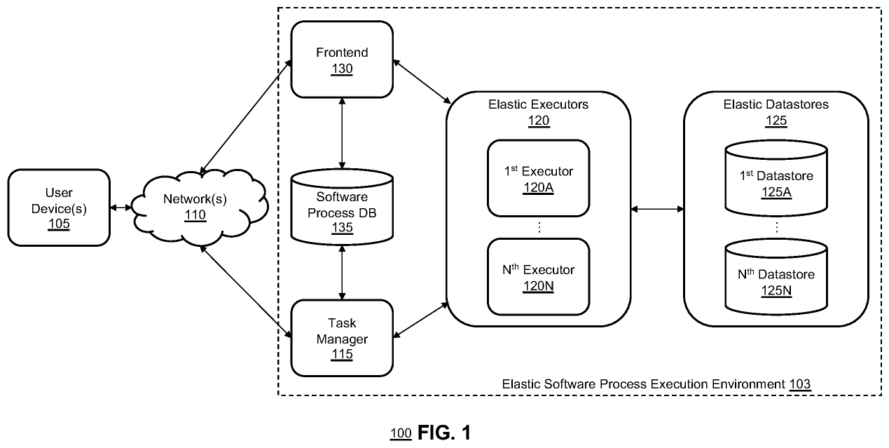

FIG. 1 shows an example environment 100 for an elastic software process execution environment 103 using an object-based model comprising a plurality of process nodes. The environment 100 may include user device(s) 105, network(s) 110, and the elastic software process execution environment 103. In some cases, the elastic software process execution environment 103 may include a task manager 115, elastic executors 120, elastic datastores 125, a frontend 130, and a software process database 135. Generally, the elastic software process execution environment 103 may interact with users to generate (or convert from existing) user-defined software processes and execute the user-defined software processes in an elastic environment. In some cases, the elastic software process execution environment 103 may have a compute layer, a storage layer, and a task manager, each of which can scale independently. In some cases, the compute layer's scale is bounded by the task manager's scale. Software processes, including starting a software process, may be abstracted as tasks that executors (e.g. pull and execute) to advance software processes. For instance, an executor may: pull a next task (e.g., query and receive) from a sub-group (e.g., from the task manager 115); retrieve a portion of code corresponding to the next task (e.g., from the software process database 135); execute the portion of code (e.g., retrieve data for one or more variables from local cache or a datastore 125, perform computations or inferences on retrieved data) to generate an updated variable or new variable; store, record, or output the updated variable or new variable (e.g., in cache or datastore 125, or to a separate system). The storage layer may persist process state, both external (e.g. variables of a software process) and internal (e.g., to the elastic software process execution environment 103).

The user device(s) 105 (hereinafter “user device 105” for ease of reference) may be a personal computing device, such as a cell phone, a tablet, a laptop, or a desktop computer. In some cases, the user device 105 may be an extended reality (XR) device, such as a virtual reality device, an augmented reality device, a mixed reality device, and the like. In some cases, the user device 105 may be associated with a user (e.g., a user of or an end user of an organization of the elastic software process execution environment 103) of services provided by the elastic software process execution environment 103. For instance, in some cases, users (e.g., employees or software functions of an organization may use (e.g., invoke) software processes to perform associated functions and actions. In some cases, users (e.g., end users of the organization, or software functions of end users (in the case the end user is also an organization) may use (e.g., invoke) software processes to perform associated functions or actions. The user may have a user account associated with the user device 105 that uniquely identifies the user (e.g., within the organization and the organization may have an organization account, or within the elastic software process execution environment 103). In some cases, the user device 105 may be a server or computer system (e.g., a cloud service) associated with the organization.

The network(s) 110 may include one or more local networks, private networks, enterprise networks, public networks (such as the internet), cellular networks, and satellite networks, to connect the various devices in the environment 100. Generally, the various devices of the environment 100 may communicate over network(s) 110 using, e.g., network communication standards that connect endpoints corresponding to the various devices of the environment 100.

The frontend 130 may be a personal computer device, a server, a system of servers, a set of compute instances in the cloud (e.g., hosted by a cloud service provider), and the like. In some cases, the frontend 130 may interact with user devices to receive user inputs regarding software processes; and add, update, or delete software processes based on the user inputs regarding software processes. For instance, the frontend 130 may host a software process development interface to enable users of user devices 105 to define, configure, and/or update software processes. In some cases, the software process development interface may enable the users to define software processes using a no-code or low code process.

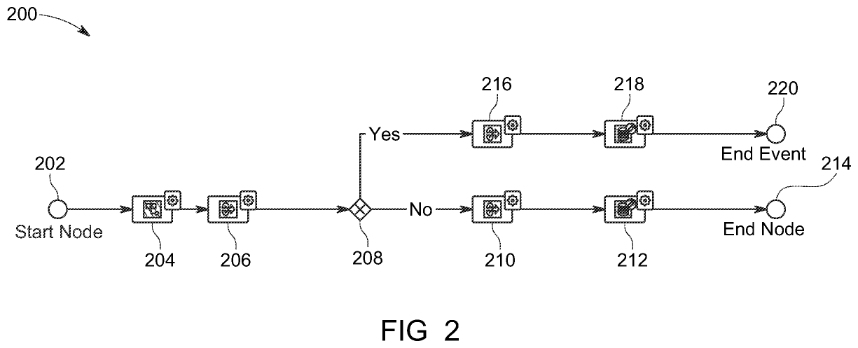

Generally, the software processes, each individually, may be configured to be represented in an object-based model. In some cases, the object-based model may be a graphical model. See, e.g., FIG. 2. An object-based model for a software process may include a at least one process node, a set of process nodes (e.g., any of 1 to N nodes), and/or or a plurality of process nodes (see, as an example, process nodes 202-220). The plurality of process nodes may include at least a first process node and a second process node. Each of the process nodes of the plurality of process nodes may correspond to a software subroutine. A software subroutine may include a discrete portion (or portions) of software executable code that advance a software process. In some cases, at least a first set of the plurality of process nodes, in accordance with software subroutines, may retrieve and perform operations on values of variables associated with the software process, as discussed herein.

In some cases, the frontend 130 may initiate specific software processes in response to triggering conditions associated with the specific software processes. In some cases, the triggering conditions may be defined by the designer of the model (e.g., the end-user performing some action through a user interface, such as inputting data or submitting a form, or upon exceeding some threshold time after the end of a previous event)) or determined or suggested by the elastic software process execution environment 103. In some cases, the triggering conditions may be (1) time-based, and/or (2) event-based. A time-based triggering condition may initiate the specific software process at a set interval (e.g., each day, each hour, and the like). An event-based triggering condition may initiate the specific software process in response to (1) a request from a user device 105 (e.g., a server of the organization), (2) a request from a different software process, (3) a request from a third-party server (e.g., a different service associated with the organization), and/or (4) a detection of a change in data stored in the elastic datastores 125.

The software process database 135 may be a structured or unstructured database or other data storage system (e.g., time series database, a data lake, etc.). The software process database 135 may store software processes for users/organizations. The software process database 135 may provide (all or subroutines of) software processes to elastic executors 120, so that the elastic executors 120 may execute tasks associated with nodes of the software processes, as discussed herein. In response to instructions from the frontend 130, the software process database 135 may add software processes, update software processes (e.g., modify subroutines, arrangement of process nodes, etc.), or delete software processes. The software process database 135 may store and manage the software processes in association with user or organization identifiers. The software process database 135 may restrict access to specific users (or groups of users) and/or specific organizations. In some cases, the software process database 135 may be omitted, and the elastic datastores 125 may receive, store, manage, and serve the software processes (or components thereof) in the environment 100.

The elastic executors 120 may be zero, one, or a plurality of executors. The elastic executors 120 may be a compute layer for the elastic software process execution environment 103. The elastic executors 120 may be configured to execute tasks associated with software processes. The tasks may be entire subroutines or parts of subroutines (e.g., loop instances, recursive instances, or parallel parts of a subroutine associated with a process node). The elastic executors 120 may be elastic and stateless. An executor of the elastic executors 120 may be a single-tenant compute instance (i.e., association with a single user or organization). In some cases, the elastic executors 120 may be a set of virtual machines (VMs). For instance, the VMs may be java virtual machines (JVMs). In some cases, the elastic executors 120 may consume work requests from a work request queue (e.g., managed by the task manager 115, discussed below). In some cases, the elastic executors 120 may be expression-evaluation environments that load (in-memory) types, usernames, rules, functions, smart services (a process node with a specific functionality and whose attributes can be specified by the designer), etc. referenced by the tasks the elastic executors 120 consume.

In some cases, the elastic executors 120 may, based on executor load (e.g., software process load, metrics of individual executors, metrics of software processes, etc.) and other factors, add or remove executors from the elastic software process execution environment 103. Thus, the elastic executors 120 may include zero, one, or a plurality of executors, as the load on the elastic software process execution environment 103 increases or decreases. As depicted in FIG. 1, the elastic executors 120 may include a first executor 120A through a Nth executor 120N, where the number of executors, N, is determined based on the load. As the load increases, new executors may be added to distribute process load across all executors of the elastic executors 120. In some cases, new executors may receive tasks from existing executors. As the load decreases, existing executors may migrate tasks to remaining executors and end decommissioned executors. In some cases, migrated tasks may be moved between VMs on a same compute instance (e.g., server), or between VMs on different compute instances (e.g., servers).

For a specific initiation of a software process on the elastic software process execution environment 103, the elastic software process execution environment 103 may determine a subset (i.e., all or less than all) of elastic executors 120 to execute tasks associated with one or more of the plurality of process nodes of the software process. The other (if any) executors of the elastic executors 120 may execute tasks associated with other (if any) software processes.

The elastic datastores 125 may be zero, one, or a plurality of datastores, such as structured or unstructured databases or other data storage systems (e.g., time series database, a data lake, etc.). The elastic datastores 125 (e.g., a first datastore, 125A) may be a storage layer for the elastic software process execution environment 103. The elastic datastores 125 may be configured to store values of variables associated with software processes. The elastic datastores 125 may be elastic and stateful. In some cases, the elastic datastores 125 may be multi-tenant cloud storage systems (e.g., from Amazon AWS®). In some cases, the elastic datastores 125 may be a set of DynamoDB tables.

The elastic datastores 125 may be exposed to elastic executors 120 through a key-value application programming interface (API) to abstract the storage implementation in a storage layer. In some cases, the elastic datastores 125 may be configured to store design and runtime information for both user (or organization) and system data. For instance, the elastic datastores 125 may store software subroutines (of the object-based model from the software process database 135), process variables (variables accessible to any node in a software process), node variables (variables accessible to a particular node in a software process), internal state data associated with the particular attributes of a running process, error and debugging information, and/or statistical information or aggregate data about running or completed processes. Process executors may retrieve any of the following types of data, or any other data associated with one or more processes, by providing the appropriate key to the API to retrieve the data (i.e., value) from the datastore.

In some cases, the elastic datastores 125 may, based on storage load (e.g., storage load, software process load, etc.) and other factors, add or remove datastores from the elastic software process execution environment 103. Thus, the elastic datastores 125 may include zero, one, or a plurality of datastores, as the load on the elastic software process execution environment 103 increases or decreases. As depicted in FIG. 1, the elastic datastores 125 may include a first datastore 125A through a Nth datastore 125N, where N is determined based on the load. As the load increases, new datastores may be added to distribute input/output process time and/or distribute storage size across all datastores of the elastic datastores 125. In some cases, new datastores may receive migrated data from existing datastores. As the load decreases, existing datastores may migrate data to remaining datastores and end decommissioned datastores. In some cases, migrated data may be moved between datastores on a same storage device, or between datastores on different storage devices.

The task manager 115 may assign process nodes or tasks of process nodes to specific executor(s) of the plurality of executors. The means by which the assignment is conducted is by examining the information contained in a work request. A work request is a message sent from either the frontend 130 or one of the elastic executors 120 to the task manager 115 that contains all information required by one of the elastic executors 120 to carry out at least one task associated with at least one process node. In some cases, the task manager 115 may assign the first process node to a first executor of the plurality of executors, such that tasks associated with the first process node will be executed by the first executor, and assign the second process node to a second executor of the plurality of executors, such that tasks associated with the second process node will be executed by the second executor. In this manner, the elastic software process execution environment 103 may execute the software process that was initiated by the frontend 130. When executing the initiated software process, the elastic software process execution environment 103 may: execute, using the first executor, a first set of tasks associated with the first process node. In this case, the execution of the first set of tasks may cause at least a first value of the variables associated with the software process to be modified in the first datastore. Moreover, when executing the initiated software process, the elastic software process execution environment 103 may: execute, using the second executor, a second set of tasks associated with the second process node. In this case, the executing of the second set of tasks may cause at least the first value of the variables associated with the software process to be again modified in the first datastore. In some cases, the task manager 115 may assign process nodes or tasks thereof in various methods, such as based on storage load or executor load, and the like.

In some cases, the task manager 115 may include a set of partitioned Kafka® topics. In these cases, a work request may be enqueued onto a partition of a Kafka topic. That work request will eventually be consumed by an executor, resulting in the evaluation of some amount of software code (which could correspond to less code than is required to evaluate a single process node or correspond to the code for multiple process nodes). The executors consume work requests to advance individual software processes. A set of executors may cooperate to consume work requests from a specific topic. The number of partitions in a topic may determine a level of parallelism in the elastic software process execution environment 103. At any given time, one partition may be consumed by exactly one executor, while multiple partitions may be consumed by a single executor. When work requests can be parallelized, the task manager 115 may enqueue (i.e., assign) work requests to different partitions (whether in random fashion or by algorithmically assigning specific work requests to specific partitions). Work requests are consumed sequentially from a single partition. The order in which they are consumed corresponds to the order in which they are enqueued on the partition. The elastic executors 120A-N may enqueue related (i.e., using the same variables or having one be dependent in some way on the other) or unrelated work (i.e., not using the same variables and not being dependent in some way on the other) requests on a single partition. Because work requests are consumed sequentially, the execution of work requests enqueued later on a single partition will be delayed relative to the execution of work requests earlier in the queue. In these cases, software process metrics and/or executor metrics may re-balance work requests, either those already assigned or incoming work requests.

The system may route work requests in different ways. As one example, an executor may, based on evaluating system metrics, user configuration, or other data available to the executor, create a work request that will be enqueued in the work request queue. Such work requests may correspond to the work needed to process multiple nodes. As is evident, the processing of some work requests may result in the execution of multiple nodes in a process. As another example, an executor may create a work request that will not be enqueued. Rather, the executor will immediately execute the work request. In this latter example, the executor can determine to execute work requests without involving the task manager 115.

In some cases, executing the first set of tasks may cause at least a first value of the variables associated with the software process to be modified in the first datastore. Subsequently, executing the second set of tasks may cause at least the first value of the variables associated with the software process to be again modified in the first datastore.

In some cases, the executors are hosted on a plurality of hardware systems. For instance, the hardware systems may have different cache sizes, different processors, GPUs, etc. In some cases, the first executor may be hosted on a first hardware system, and the second executor may be hosted on a second hardware system. The first hardware system may be configured differently than the second hardware system.

In some cases, the first datastore (e.g., the first datastore 125A) is accessible to all of the executors associated with the process nodes of the first software process. In some cases, the executors associated with the process nodes may be able to access all datastores 125. In some cases, the executors associated with the process nodes may be able to access only those datastores associated with a particular user or organization.

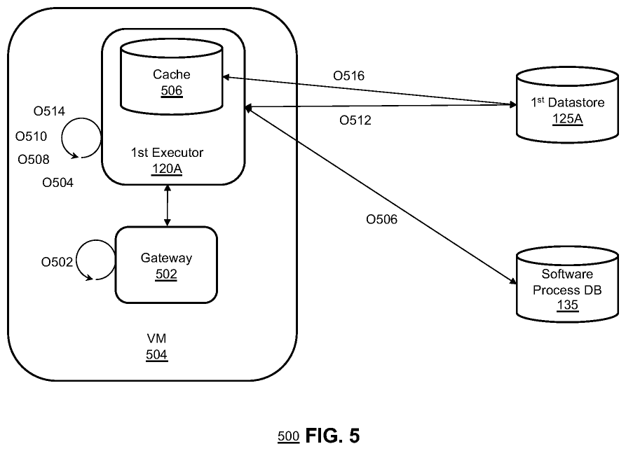

In some cases, the software process may include a third process node configured to perform operations related to a common variable on which the first process node also operates. The task manager 115 may be configured to determine that the first process node and the third process node operate on the common variable and, based at least in part on this determination, assign the first process node and the third process node to a common executor (e.g., the first executor 120A). In some cases, the first executor 120A may be associated with a local cache accessible by the first executor 120A but not by the second executor. In this case, when the first executor 120A performs a first task associated with, e.g., the first process node, the first executor may modify a value for a common variable in the local cache. When the first executor 120A performs a second task associated with the third process node, the first executor 120A may retrieve the value for the common variable from the local cache. See, e.g., FIG. 5.

In some cases, when the first executor 120A performs a third task associated with the third process node, the first executor 120A may determine that a second variable value is not available in the local cache. In this case, the first executor 120A may, in response, retrieve the second variable value from the first datastore (e.g., the elastic datastore 125).

In some cases, the first executor 120A (or an associated program) may be configured to manage data stored on the local cache by syncing data with the first datastore (e.g., the elastic datastore 125). In this manner, the local cache may have (e.g., before a task is started) data relevant to the task to perform. Additionally or alternatively, in this manner, the software process nodes may execute subroutines on user-defined software processes without end users (e.g., users or organizations) handling the process variables in between the elastic executors 120. Instead, the elastic executors 120 and the elastic datastores 125 may manage process variables, and the end users may define abstracted levels of software functions. In this manner, best practices and/or efficient execution may be managed by knowledgeable engineers of the elastic software process execution environment 103 (thus reducing errors, delay, etc.), while output functionality is designed by end users (thus, producing business/engineering results).

In some cases, in response to an instruction to execute the software process, the frontend 130 or one of the process executors 120A-N may generate a plurality of work requests based on the plurality of process nodes. To assign a first set of work requests to the first executor 120A and a second set of work requests to the second executor (and similarly the Nth set of work requests to the Nth executor 120N), the task manager 115 may be configured to, based on load-balancing rules: assign the first set of work requests to a first sub-group of a first group and assign the second set of work requests to a second sub-group of the first group (and similarly assign the Nth set of work requests to the Nth sub-group of a first group). The first executor 120A may be assigned to pull pending work requests from the first sub-group, and the second executor may be assigned to pull pending work requests from the second sub-group (and similarly the Nth executor may be assigned to pull pending work requests from the Nth sub-group).

In some cases, the first sub-group and the second sub-group are sub-groups of a first set of sub-groups associated with the first group. In some cases, the first group is one of a first set of groups associated with an organization (e.g., the organization). In this manner, the work requests and executors 120 are separated and data leaks may be reduced. The first set of sub-groups may be elastic within the first group. The first set of groups may be elastic for the organization.

In some cases, the load-balancing rules may be configured to assign the plurality of work requests to sub-groups based on (1) dependencies between the process nodes, (2) number of already assigned work requests for each sub-group, (3) compute resources being utilized by the executors, (4) throughput/latency metrics of the executors, and (5) throughput/latency metrics of the software process.

To generate the plurality of work requests based on the plurality of process nodes, the task manager 115 may be configured to: generate at least one work requests for each process node of the plurality of process nodes. In the case that a process node is indicated to be a parallel process node or a multi-task process node, the task manager 115 may be configured to: generate at least two work requests for the process node. In some cases, the two work requests may be processed on different threads of a same executor. In some cases, the two work requests may be processed on different executors.

### Object-Based Model

FIG. 2 depicts a diagram schematically showing an object-based model 200 comprising a plurality of process nodes 202-220. The features of the object-based model 200 of FIG. 2 may apply to FIGS. 1, 3, 4A-4B, 5 and 6.

The object-based model 200 may be a graphical model stored in the software process database 135. The nodes of the object-based model 200 may correspond to software subroutines of the software process.

The plurality of process nodes 202-220 may include, at least, a start node 202, at least one end node 214/220, and optionally may include one or more intermediate nodes 204-212 and 216-218.

The start node 202 may initiate the software process. For instance, the start node 202 may be associated with the triggering conditions to start the software process. In response to a triggering condition initiating the software process, the start node 202 may cause the assigned executors of other nodes, such as at the least one or more intermediate nodes 204-212 and 216-218, to retrieve and store (e.g., in the first datastore 125A) associated code and/or connections (e.g., pointers to local caches or API key values for software process variables) (collectively, “preparation actions”). In some cases, additionally or alternatively, the start node 202 may be a timing mechanism to determine, e.g., metrics for the executor and/or the software process. In the case that the preparation actions are handled by the elastic software process execution environment 103, the start node 202 may solely perform as a timing mechanism.

The at least one end node 214/220 may end the software process. For instance, an end node 214 or the end node 220 may indicate an end of the timing mechanism of the software process. The end node 220 may also indicate to the elastic executor 120A-N that the software process is ended. In some cases, the software process may include end nodes that indicate an end at different points in time (i.e., branches that are not exclusive) and each branch may end at different points in time. In some cases, the software process may include end nodes that indicate an end of the entire software process, even if other branches of the process were still being executed.

The at least one or more intermediate nodes 204-212 and 216-218 may perform various functions. For instance, tasks of the intermediate nodes' executors may be to perform one or combinations of: (a) retrieving a first set of values for the variables of the first software process and/or retrieve data from a different system (collectively, input data); (b) performing a function to (1) transform the input data, (2) determine a logical result of a logical expression on the input data, and/or (3) infer one or more inferences based on the input data (collectively, output data); and (b) storing the output data as a new value of a specific variable, store the output data as a value of a newly instantiated variable of the first software process, and/or create, update or delete a record.

For instance, to retrieve the first set of values, the task may determine whether to access a local cache or the elastic datastores 125, and retrieve data bits therefrom, or it may determine the value of an input to an expression by evaluating an expression specified by the designer in an expression language. In some cases, the task may determine to access other systems (e.g., third parties or associated systems of the elastic software process execution environment 103). For instance, node 204 may retrieve data associated with an event that triggered the software process depicted in FIG. 2.

In some cases, a node may transform data in the software process. For instance, node 206 may transform input data into a defined format.

In some cases, a node may determine a logical result based on variables of the software process. For instance, node 208 may determine which branch (or multiple branches) to advance based on values of the variables of the software process. A logical expression may be arbitrarily complex based on input values and logical operators.

In some cases, a node may determine a calculation (e.g., of a deterministic process) or an inference (e.g., of a machine learning process) based on variables or sets of variables retrieved in earlier steps. For instance, node 216 may determine a calculation, while node 210 determines an inference based on the same or different variables of the software process.

In some cases, a node may store output data as a value of a variable (existing or new) or a record. For instance, nodes 212 and 218 may create or update records with data output by previous nodes. In some cases, intermediate values (e.g., those that do not populate a record during the software process) may be cleared before another software process executes.

In some cases, such as node 210, the task manager 115 may determine several tasks that correspond to the node 210. The several tasks may be performed in sequence (on a same executor) or on separate executors (or threads thereof) in parallel depending on configurations supplied by the designer of the node. For instance, node 210 may perform a loop functionality (e.g., a loop instance) or multiple node instance (MNI) functionality. MNI functionality may repeat a same set of actions multiple times (e.g., with different data, updated data, and the like).

### Assignment

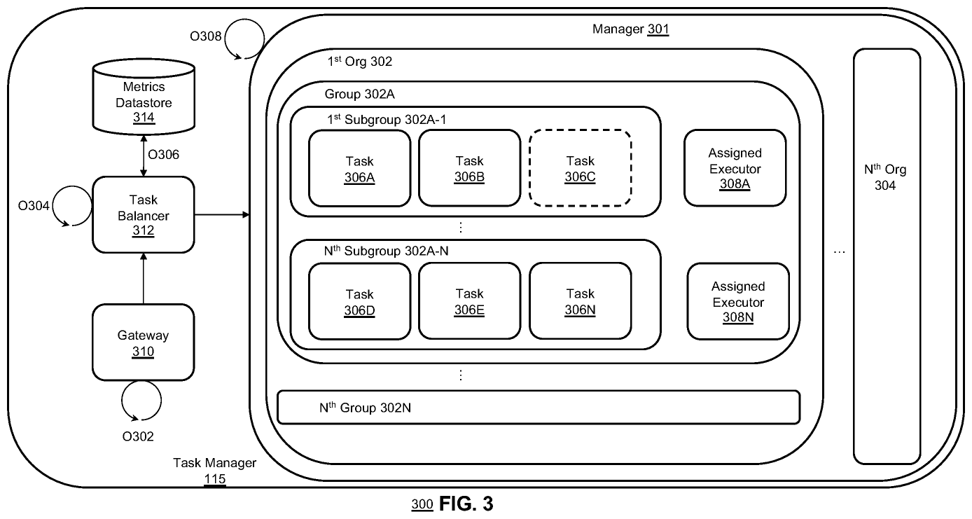

FIG. 3 depicts a block diagram 300 schematically showing how tasks are assigned to executors in an elastic software process execution environment. The features of the block diagram 300 of FIG. 3 may apply to FIGS. 1, 2, 4A-4B, 5 and 6. In particular, the assignment of tasks may be performed by the task manager 115. The task manager 115 may include a manager 301, a gateway 310, a task balancer 312, and metrics datastore 314. The task manager 115 may perform operations O302 through O308.

The gateway 310, in operation O302, may initiate assignment of tasks. For instance, the gateway 310 may determine a triggering condition for a software process has been satisfied or initiate assignment in response to a request from the frontend 130.

In some cases, the manager 301 may manage a plurality of task queues for a plurality of organizations, such as a first organization 302 through an Nth organization 304. In some cases, the manager 301 may manage a task queue for a single organization.

For a single organization, such as the first organization, the manager 301 may manage groups, including group 302A through Nth group 302N, and sub-groups of each group (such as subgroups 302A-1 through 302A-N for a first group 302A). Each subgroup 302A-1 through 302A-N may queue tasks. For instance, as depicted, the first subgroup 302A-1 may have tasks 306A and 306B, and an Nth subgroup 302A-N may have tasks 306D, 306E, and 306N. Moreover, each subgroup 302A-1 through 302A-N may have an assigned executor 308A through assigned executor 308N. The assigned executor 308A may be the same or different from the assigned executor 308.

The task balancer 312, in operation O304, may request metrics from metrics datastore 314, and in response to receiving metrics, in operation O306 (e.g., as the metrics are updated on as-requested basis), determine assignment of tasks to subgroups. For instance, based on storage or executor loads, the task balancer may add new task 306C to the first subgroup 302A-1. In response, the manager 301 may, in operation O308, add new task 306C to the first subgroup 302A-1.

The metrics datastore 314 may store (at the current instance, or over time, collectively “metrics”) a number of already assigned tasks for each sub-group, compute resources being utilized by the executors, throughput/latency metrics of the executors, and/or throughput/latency metrics of the software process. The task balancer 312 may use the metrics (and dependencies of nodes) to assign tasks to executors.

### Dataflow Diagram

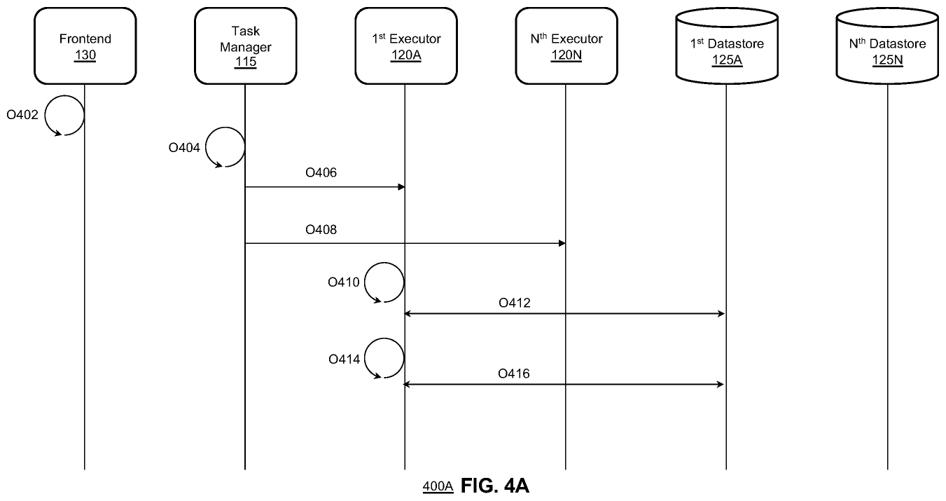

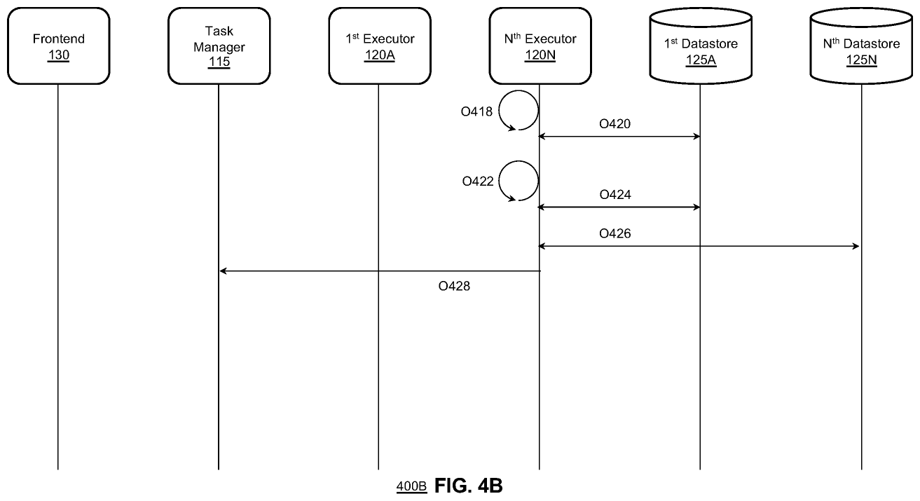

FIGS. 4A and 4B depict dataflow diagrams 400A and 400B for a software process hosted on an elastic software process execution environment. The features of the dataflow diagrams 400A and 400B of FIGS. 4A and 4B may apply to FIGS. 1, 2, 3, 5 and 6. The dataflow diagrams 400A and 400B of FIGS. 4A and 4B may include operations O402 through O428. The operations O402 through O428 may be performed by various devices of the environment 100.

In operation O402, the frontend 130 may interact with user devices to define/update user-defined software process. As discussed herein, the frontend 130 may provide a low-code or no-code user interface to define or update the software process. The frontend 130 may then update the software process database 135 with the new or updated software process.

In operation O404, the task manager may determine that a software process has been triggered and determine a plurality of tasks for a subset of executors of the elastic executors 125. For instance, the tasks may be assigned based on dependency between nodes and historical metrics of the software process and metrics of the executors for the current instance or instances of the process.

In operation O406 and operation O408, the task manager 115 may transmit notifications and requests to specific executors, such as the first executor 120A and the Nth executor 120N. The notifications may inform the executors of tasks in their queue of a subgroup. A request may create a new executor and assign the new executor to an existing or new subgroup.

In operation O410, the first executor 120A may, for a task, retrieve a portion of code for a subroutine corresponding to the task (e.g., from the software process database 135 or the elastic datastores 125, if pre-populated), and determine data needed to run the subroutine. In operation O412, the first executor 120A may retrieve the data needed to run the subroutine. In operation O414, the first executor 120A may process the retrieved data in accordance with the portion of the code for the subroutine. In operation O416, the first executor 120A may update the values of certain variables of the software process (as indicated by dependencies of the nodes).

In operation O418, the Nth executor 120N may, after the first executor 120A updated the values of the variables, for a task, retrieve a portion of code for a subroutine corresponding to the task (e.g., from the software process database 135 or the elastic datastores 125, if pre-populated), and determine data needed to run the subroutine. In operation O420, the Nth executor 120N may retrieve the data needed to run the subroutine. In operation O422, the Nth executor 120N may process the retrieved data in accordance with the portion of the code for the subroutine.

Based on the software process, the system may perform various operations. In operation O424, the Nth executor 120N may update the values of certain variables of the software process (as indicated by dependencies of the nodes). In operation O426, the Nth executor 120N may generate or update a record in a datastore, such as the Nth datastore 125N. In operation O428, the Nth executor 120N may trigger a new software process, update metrics data, and the like, by transmitting a message to the task manager 115 (or the frontend 130).

### Executor

FIG. 5 depicts a block diagram 500 schematically showing how tasks are executed on executors in an elastic software process execution environment. The features of the block diagram 400 schematically showing how tasks are executed on executors of FIG. 5 may apply to FIGS. 1, 2, 3, 4A-4B, and 6. The block diagram 500 of FIG. 5 may include operations O502 through O516. The operations O502 through O516 may be performed by various devices of the environment 100, including, for example, the first executor 120A, the software process database 135, the first datastore 125A. The first executor 120A may include a cache 506 and be executed within a virtual machine (VM) 504 and be connected to a gateway 502.

In operation O502, the gateway 502 may determine a next task to be executed. For instance, while executing a current task, the gateway 502 may determine a task in accordance with a subgroup or subgroups.

In operation O504, the VM 504 may determine to retrieve specific code to execute a subroutine of the next task from the software process database 135 (or the elastic datastore 125, if pre-populated). In operation O506, the VM 504 may pull the specific code for the subroutine.

In operation O508, the VM 504 may determine which data (e.g., not dependent on the current task of the VM 504) to pull. In operation O510, the VM 504 may determine cached data, and pull the cached data as input data. In operation O512, the VM 504 may determine non-cached data, and pull the non-cached data as input data.

In operation O514, the VM 504 may process the input data and update the cache 506 and/or the first datastore 125A.

In operation O516, in the case that the VM 504 did not update the first datastore 125A, the cache 506 may sync data with the first datastore 125A. For instance, a sync program may coordinate caches of executors and datastores. For instance, the sync program may (1) cross populate updated or new software process variables as they are updated by different executors in accordance with node dependency, or (2) delete process variables when a software process ends (e.g., at an end node). For instance, the sync program may be alerted by VM 504 (or cache 506) when an update to an existing software process variable or new software process variable is added to the cache 506, and the sync program may retrieve and distribute the updated or new variable to a datastore 125 or caches 506 of other executors that are assigned to process nodes that depend on the updated or new variable.

### Computer System

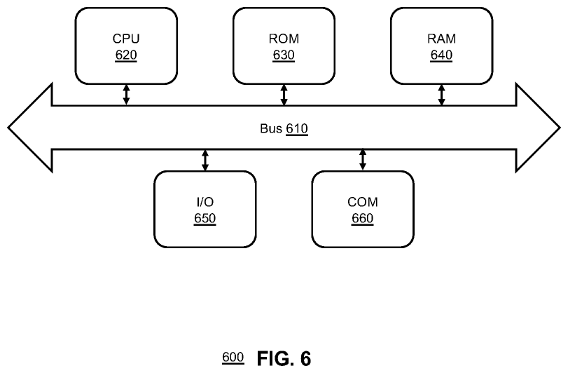

FIG. 6 depicts an example system that may execute techniques presented herein. FIG. 6 is a simplified functional block diagram of a computer that may be configured to execute techniques described herein, according to exemplary cases of the present disclosure. Specifically, the computer or group of computers pooling resources and resembling a single computer, i.e., a “platform,” may include a data communication interface 660 for packet data communication. The platform may also include a central processing unit (“CPU”) 620, in the form of one or more processors, for executing program instructions. The platform may include an internal communication bus 610, and the platform may also include a program storage and/or a data storage for various data files to be processed and/or communicated by the platform such as ROM 630 and RAM 640, although the system 600 may receive programming and data via network communications. The system 600 also may include input and output ports 650 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted or explained in this disclosure. Although not required, aspects of the present disclosure are described in the context of computer-executable instructions, such as routines executed by a data processing device, e.g., a server computer, wireless device, or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of +10% in a stated value.

The term “exemplary” is used in the sense of “example” rather than “ideal.” As used herein, the singular forms “a,” “an,” and “the” include plural reference unless the context dictates otherwise.

### Examples

Exemplary embodiments of the systems and methods disclosed herein are described in the numbered paragraphs below.
A1. A system for elastic execution of user-defined software processes, the system comprising:
a frontend configured to receive user inputs related to a software process, wherein:
   the software process is configured to be represented in an object-based model comprising a plurality of process nodes, the plurality of process nodes comprising at least a first process node and a second process node; and
   at least a set of the plurality of process nodes retrieve and perform operations on values of variables associated with the software process;
at least one datastore configured to store the values of the variables associated with the software process;
a plurality of executors, each of the plurality of executors being configured to execute tasks associated with one or more of the plurality of process nodes;
wherein the system is configured to:
assign the first process node to a first executor of the plurality of executors, such that tasks associated with the first process node will be executed by the first executor;
assign the second process node to a second executor of the plurality of executors, such that tasks associated with the second process node will be executed by the second executor; and
execute the software process, wherein executing the software process comprises:
   assigning, to the first executor, a first set of tasks associated with the first process node, wherein executing the first set of tasks causes at least a first value of the variables associated with the software process to be modified in the at least one datastore; and
   assigning, to the second executor, a second set of tasks associated with the second process node, wherein executing the second set of tasks causes at least the first value of the variables associated with the software process to be again modified in the at least one datastore.
A2. The system of A1, wherein the object-based model is a graphical model.
A3. The system of any of A1-A2, wherein executing the first set of tasks causes at least a first value of the variables associated with the software process to be modified in the at least one datastore; and executing the second set of tasks causes at least the first value of the variables associated with the software process to be again modified in the at least one datastore.
A4. The system of any of A1-A3, wherein the plurality of executors are hosted on a plurality of hardware systems.
A5. The system of A4, wherein the first executor is hosted on a first hardware system, the second executor is hosted on a second hardware system, and the first hardware system is configured differently than the second hardware system.
A6. The system of any of A1-A5, wherein the at least one datastore is accessible to all of the plurality of executors associated with the plurality of process nodes of the software process.
A7. The system of any of A1-A6, wherein the software process includes a third process node configured to perform operations related to a common variable on which the first process node also operates, and the system is configured to determine that the first process node and the third process node operate on the common variable and, based at least in part on this determination, assign the first process node and the third process node to a common executor.
A8. The system of A7, wherein the first executor is associated with a local cache accessible by the first executor but not by the second executor; when the first executor performs a first task associated with the first process node, the first executor modifies a value for the common variable in the local cache; when the first executor performs a second task associated with the third process node, the first executor retrieves the value for the common variable from the local cache.
A9. The system of A8, wherein when the first executor performs a third task associated with the third process node, the first executor determines that a second variable value is not available in the local cache and, in response, retrieves the second variable value from the at least one datastore.
A10. The system of A8, wherein the first executor is configured to: manage data stored on the local cache by syncing data with the at least one datastore.
A11. The system of any of A1-A10, wherein the plurality of executors are configured to perform one or combinations of: retrieving a first set of values for the variables of the software process and/or retrieve data from a different system (collectively, input data); performing a function to (1) transform the input data, (2) determine a logical result of a logical expression on the input data, and/or (3) make one or more inferences based on the input data (collectively, output data); and/or storing the output data as a new value of a specific variable, store the output data as a value of a newly instantiated variable of the software process, and/or create, update or delete a record.
A12. The system of any of A1-A11, wherein the system further includes a task manager configured to, in response to an instruction to execute the software process, generate a plurality of tasks based on the plurality of process nodes.
A13. The system of A12, wherein to assign the first set of tasks to the first executor and the second set of tasks to the second executor, the task manager is configured to, based on load-balancing rules: assign the first set of tasks to a first sub-group of a first group associated with an organization and assign the second set of tasks to a second sub-group of the first group.
A14. The system of A13, wherein the first executor is assigned to pull pending tasks from the first sub-group, and the second executor is assigned to pull pending tasks from the second sub-group.
A15. The system of A13, wherein the first sub-group and second sub-group are sub-groups of a first set of sub-groups associated with the first group, and the first group is one of a first set of groups associated with an organization, the first set of sub-groups are elastic within the first group, and the first set of groups are elastic for the organization.
A16. The system of A13, wherein the load-balancing rules are configured to assign the plurality of tasks to sub-groups based on (1) dependencies between the plurality of process nodes, (2) number of already assigned tasks for each sub-group, (3) compute resources being utilized by the plurality of executors, (4) throughput/latency metrics of the plurality of executors, and (5) throughput/latency metrics of the software process.
A17. The system of A13, wherein, to generate the plurality of tasks based on the plurality of process nodes, the task manager is configured to: generate at least one task for each process node of the plurality of process nodes.
A18. The system of A17, wherein, when a process node is indicated to be a parallel process node or a multi-task process node, the task manager is configured to: generate at least two tasks for the process node.
A19. The system of A18, wherein the at least two tasks are handled on different threads of a single executor.
A20. The system of A1, wherein a task of the first set of tasks associated with the first process node is configured to invoke execution of the software process or a different software process.
A21. A computer-implemented method for elastic execution of user-defined software processes, the computer-implemented method comprising:
receiving user inputs related to a software process, wherein:
   the software process is configured to be represented in an object-based model comprising a plurality of process nodes, the plurality of process nodes comprising at least a first process node and a second process node;
   each of the plurality of process nodes of the plurality of process nodes corresponds to a software subroutine; and
   at least a set of the plurality of process nodes retrieve and perform operations on values of variables associated with the software process;
storing the values of the variables associated with the software process;
assigning the first process node to a first executor of a plurality of executors, such that tasks associated with the first process node will be executed by the first executor;
assigning the second process node to a second executor of the plurality of executors, such that tasks associated with the second process node will be executed by the second executor; and
executing the software process, wherein executing the software process comprises:
   executing, using the first executor, a first set of tasks associated with the first process node, wherein executing the first set of tasks causes at least a first value of the variables associated with the software process to be modified in at least one datastore; and
   executing, using the second executor, a second set of tasks associated with the second process node, wherein executing the second set of tasks causes at least the first value of the variables associated with the software process to be again modified in at least one datastore.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for elastic execution of user-defined software processes, the system comprising:
a frontend configured to receive user inputs related to a software process, wherein:
the software process is configured to be represented in an object-based model comprising a plurality of process nodes, the plurality of process nodes comprising at least a first process node and a second process node; and
at least a set of the plurality of process nodes retrieve and perform operations on values of variables associated with the software process;
at least one datastore configured to store the values of the variables associated with the software process;
a plurality of executors, each of the plurality of executors being configured to execute tasks associated with one or more of the plurality of process nodes;
wherein the system is configured to:
assign the first process node to a first executor of the plurality of executors, such that tasks associated with the first process node will be executed by the first executor;
assign the second process node to a second executor of the plurality of executors, such that tasks associated with the second process node will be executed by the second executor; and
execute the software process, wherein executing the software process comprises:
assigning, to the first executor, a first set of tasks associated with the first process node, wherein executing the first set of tasks causes at least a first value of the variables associated with the software process to be modified in the at least one datastore; and
assigning, to the second executor, a second set of tasks associated with the second process node, wherein executing the second set of tasks causes at least the first value of the variables associated with the software process to be again modified in the at least one datastore.

2. The system of claim 1, wherein the object-based model is a graphical model.

3. The system of claim 1, wherein executing the first set of tasks causes at least a first value of the variables associated with the software process to be modified in the at least one datastore; and executing the second set of tasks causes at least the first value of the variables associated with the software process to be again modified in the at least one datastore.

4. The system of claim 1, wherein the plurality of executors are hosted on a plurality of hardware systems.

5. The system of claim 4, wherein the first executor is hosted on a first hardware system, the second executor is hosted on a second hardware system, and the first hardware system is configured differently than the second hardware system.

6. The system of claim 1, wherein the at least one datastore is accessible to all of the plurality of executors associated with the plurality of process nodes of the software process.

7. The system of claim 1, wherein the software process includes a third process node configured to perform operations related to a common variable on which the first process node also operates, and the system is configured to determine that the first process node and the third process node operate on the common variable and, based at least in part on this determination, assign the first process node and the third process node to a common executor.

8. The system of claim 7, wherein the first executor is associated with a local cache accessible by the first executor but not by the second executor; when the first executor performs a first task associated with the first process node, the first executor modifies a value for the common variable in the local cache; when the first executor performs a second task associated with the third process node, the first executor retrieves the value for the common variable from the local cache.

9. The system of claim 8, wherein when the first executor performs a third task associated with the third process node, the first executor determines that a second variable value is not available in the local cache and, in response, retrieves the second variable value from the at least one datastore.

10. The system of claim 8, wherein the first executor is configured to: manage data stored on the local cache by syncing data with the at least one datastore.

11. The system of claim 1, wherein the plurality of executors are configured to perform one or combinations of: retrieving a first set of values for the variables of the software process and/or retrieve data from a different system (collectively, input data); performing a function to (1) transform the input data, (2) determine a logical result of a logical expression on the input data, and/or (3) make one or more inferences based on the input data (collectively, output data); and/or storing the output data as a new value of a specific variable, store the output data as a value of a newly instantiated variable of the software process, and/or create, update or delete a record.

12. The system of claim 1, wherein the system further includes a task manager configured to, in response to an instruction to execute the software process, generate a plurality of tasks based on the plurality of process nodes.

13. The system of claim 12, wherein to assign the first set of tasks to the first executor and the second set of tasks to the second executor, the task manager is configured to, based on load-balancing rules: assign the first set of tasks to a first sub-group of a first group associated with an organization and assign the second set of tasks to a second sub-group of the first group.

14. The system of claim 13, wherein the first executor is assigned to pull pending tasks from the first sub-group, and the second executor is assigned to pull pending tasks from the second sub-group.

15. The system of claim 13, wherein the load-balancing rules are configured to assign the plurality of tasks to sub-groups based on (1) dependencies between the plurality of process nodes, (2) number of already assigned tasks for each sub-group, (3) compute resources being utilized by the plurality of executors, (4) throughput/latency metrics of the plurality of executors, and (5) throughput/latency metrics of the software process.

16. The system of claim 13, wherein, to generate the plurality of tasks based on the plurality of process nodes, the task manager is configured to: generate at least one task for each process node of the plurality of process nodes.

17. The system of claim 16, wherein, when a process node is indicated to be a parallel process node or a multi-task process node, the task manager is configured to: generate at least two tasks for the process node.

18. The system of claim 17, wherein the at least two tasks are handled on different threads of a single executor.

19. The system of claim 1, wherein a task of the first set of tasks associated with the first process node is configured to invoke execution of the software process or a different software process.

20. A computer-implemented method for elastic execution of user-defined software processes, the computer-implemented method comprising:
receiving user inputs related to a software process, wherein:
the software process is configured to be represented in an object-based model comprising a plurality of process nodes, the plurality of process nodes comprising at least a first process node and a second process node;
each of the plurality of process nodes of the plurality of process nodes corresponds to a software subroutine; and
at least a set of the plurality of process nodes retrieve and perform operations on values of variables associated with the software process;
storing the values of the variables associated with the software process;
assigning the first process node to a first executor of a plurality of executors, such that tasks associated with the first process node will be executed by the first executor;
assigning the second process node to a second executor of the plurality of executors, such that tasks associated with the second process node will be executed by the second executor; and
executing the software process, wherein executing the software process comprises:
executing, using the first executor, a first set of tasks associated with the first process node, wherein executing the first set of tasks causes at least a first value of the variables associated with the software process to be modified in at least one datastore; and
executing, using the second executor, a second set of tasks associated with the second process node, wherein executing the second set of tasks causes at least the first value of the variables associated with the software process to be again modified in at least one datastore.
